(19) United States
(12) Patent Application Publication
(10) Pub. No.: US 2025/0274569 A1
(43) Pub. Date: Aug. 28, 2025

(54) ILLUMINATING SYSTEM AND PROJECTION DEVICE

(71) Applicant: Coretronic Corporation, Hsin-Chu (TW)

(72) Inventors: Chia-Hao Wang, Hsin-Chu (TW); Yao-Shun Lin, Hsin-Chu (TW); Bo-Heng Zhou, Hsin-Chu (TW)

(73) Assignee: Coretronic Corporation, Hsin-Chu (TW)

(21) Appl. No.: 19/059,298

(22) Filed: Feb. 21, 2025

(30) Foreign Application Priority Data
Feb. 23, 2024 (CN) 202410204074.0

(51) Int. Cl. H04N 9/31

(52) U.S. Cl. CPC H04N 9/3158; H04N 9/3152; H04N 9/317; H04N 9/3197

(57) ABSTRACT

An illuminating system includes a light source module and a light homogenizing element. The light source module includes at least one sub-light source module, and each sub-light source module includes a light-emitting element, a wavelength conversion element, a light-splitting element, a reflective element and a light guide element. The reflective element is configured to reflect the exited light beam converted by the wavelength conversion element to the light guide element. The light guide element includes a light incident surface, a reflective surface and a light exit surface. By designing the angle between the light incident surface of the light guide element and the light exit surface to be an acute angle, combined with the deflection configuration of the reflective element, the excited beam may be transmitted along different transmission paths without optical loss.

### CROSS-REFERENCE TO RELATED APPLICATION

This application claims the priority benefit of China application serial no. 202410204074.0, filed on Feb. 23, 2024. The entirety of the above-mentioned patent application is hereby incorporated by reference herein and made a part of this specification.

### BACKGROUND OF THE DISCLOSURE

### Field of the Disclosure

The present disclosure relates to an optical system and an electronic device, and in particular to an illuminating system and a projection device.

### Description of Related Art

The projection device is a display device used to produce large-size images. With the evolution and innovation of science and technology, projection devices have continued to advance. The imaging principle of the projection device is to convert the light beam generated by the illuminating system into an image beam through a light valve, and then the image beam is transferred to the projection lens and projected onto the projection target (such as a screen or a surface of a wall) to form a projection image. In addition, to meet the market's demands for projection device brightness, color saturation, service life, non-toxic, and environmentally friendly features, the light sources for illuminating systems have evolved from ultra-high-performance lamps (UHP lamps), light-emitting diodes (LED) to the latest laser diode (LD) light source. Moreover, integrated laser diode package including multiple diode elements is developed, making the internal configuration of the projection device more compact and enhancing optical performance.

In modern illuminating systems, internal reflective prisms with right angles are used to establish the reflective path of the light beam. When the light beam enters the internal reflective prism at the center of the light incident surface with a right angle, the light beam enters without optical loss. However, there is a risk of optical loss when a light beam enters the internal reflective prism at the edge of the light incident surface with a right angle. To avoid optical loss, the cross-sectional area of the light beam output by the wavelength conversion element should be reduced. However, such approach increases the energy density of the light beam, such that the conversion efficiency of the wavelength conversion element decreases. That is, a higher energy density of the input light beam does not necessarily generate more stimulated emission.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE DISCLOSURE

The present disclosure provides an illuminating system and a projection device, which may cause the excited light beam to have no optical loss on different transmission paths, thereby improving the light usage efficiency and improving the optical effect of the light beam.

Other objects and advantages of the present disclosure may be further understood from the technical features disclosed in the present disclosure.

In order to achieve one, part or all of the above purposes or other purposes, the present disclosure provides an illuminating system, which includes a light source module and a light homogenizing element. The illuminating system is configured to provide an illumination beam. The light source module includes at least one sub-light source module. Each sub-light source module is configured to provide a sub-illumination beam. Each sub-light source module includes a light-emitting element, a wavelength conversion element, a light-splitting element, a reflective element and a light guide element. The light-emitting element is configured to provide the first light beam. The light-splitting element guides the first light beam provided by the light-emitting element toward the wavelength conversion element. The wavelength conversion element is disposed on the transmission path of the first light beam from the light-splitting element and converts the first light beam into an excited light beam. The excited light beam is transmitted to the light-splitting element and guided toward the reflective element by the light-splitting element. The reflective element is disposed on the transmission path of the excited light beam from the light-splitting element, and is configured to reflect the excited light beam to the light guide element. The light guide element includes a light incident surface, a reflective surface and a light exit surface. The light exit surface includes a light-exiting area and a non-light-exiting area. The light-exiting area is farther from the light incident surface than the non-light-exiting area. The angle between the light incident surface and the light exit surface is an acute angle. The reflective element is configured corresponding to the light incident surface of the light guide element, so that the excited light beam enters the light guide element from the light incident surface. The excited light beam in the light guide element is reflected by the reflective surface and exits the light guide element from the light-exiting area of the light exit surface, thereby forming at least a portion of the sub-illumination beam. The light homogenizing element includes a light input end. The light input end is disposed corresponding to the light-exiting area of the light guide element of the sub-light source module, and is disposed on the transmission path of the sub-illumination beam from each sub-light source module to receive the sub-illumination beam from the light-exiting area. The illumination beam includes sub-illumination beams.

In order to achieve one, part or all of the above objects or other objects, the present disclosure further provides a projection device, including an illuminating system, at least one light valve and a projection lens. The illuminating system is configured to provide illumination beams. The illuminating system includes a light source module and a light homogenizing element. The illuminating system is configured to provide illumination beams. The light source module includes at least one sub-light source module. Each sub-light source module is configured to provide a sub-illumination beam. Each sub-light source module includes a light-emitting element, a wavelength conversion element, a light-splitting element, a reflective element and a light guide element. The light-emitting element is configured to provide the first light beam. The light-splitting element guides the first light beam provided by the light-emitting element to the wavelength conversion element. The wavelength conversion element is disposed on the transmission path of the first light beam from the light-splitting element, and converts the first light beam into an excited light beam. The excited light beam is transmitted to the light-splitting element and guided to the reflective element by the light-splitting element. The reflective element is disposed on the transmission path of the excited light beam from the light-splitting element, and is configured to reflect the excited light beam to the light guide element. The light guide element includes a light incident surface, a reflective surface and a light exit surface. The light exit surface includes a light-exiting area and a non-light-exiting area. The light-exiting area is further away from the light incident surface than the non-light-exiting area. The angle between the light incident surface and the light exit surface is an acute angle. The reflective element is configured corresponding to the light incident surface of the light guide element, so that the excited light beam enters the light guide element from the light incident surface. The excited light beam in the light guide element is reflected by the reflective surface and exits the light guide element from the light-exiting area of the light exit surface, thereby forming at least part of the sub-illumination beam. The light homogenizing element includes the light input end. The light input end is configured corresponding to the light-exiting area of the light guide element of the sub-light source module, and is disposed on the transmission path of the sub-illumination beam from each sub-light source module to receive the sub-illumination beam from the light-exiting area. The illumination beam includes sub-illumination beams. The light valve is disposed on the transmission path of the illumination beam to convert the illumination beam into an image beam. The projection lens is disposed on the transmission path of the image beam and is used to project the image beam out of the projection device.

Based on the above, embodiments of the present disclosure have at least one of the following advantages or effects. In the illuminating system and projection device of the present disclosure, the illuminating system includes a light source module and a light homogenizing element. The light source module includes at least one sub-light source module, and each sub-light source module is configured to provide a sub-illumination beam. Each sub-light source module includes a light-emitting element, a wavelength conversion element, a light-splitting element, a reflective element and a light guide element. The wavelength conversion element converts the first light beam provided by the light-emitting element into an excited light beam, and the reflective element reflects the excited light beam to the light guide element. The light guide element includes a light incident surface, a reflective surface and a light exit surface, and the angle between the light incident surface and the light exit surface is an acute angle. The light homogenizing element includes a light input end which is configured corresponding to the light-exiting area of the light exit surface of the light guide element, and is disposed on the transmission path of the sub-illumination beam from each sub-light source module to receive the sub-illumination beam from the light-exiting area. Therefore, through the design of an acute angle between the light incident surface and the light exit surface of the light guide element and the deflection configuration of the reflective element, the excited light beam may be transmitted along different transmission paths without causing optical loss. In this way, the light usage efficiency may be improved, thereby improving the optical performance of the illumination beam.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projection device according to an embodiment of the present disclosure.

FIG. 2A to FIG. 2C are schematic diagrams of the illuminating system viewed from different viewing angles according to an embodiment of the present disclosure.

FIG. 3A to FIG. 3C are schematic diagrams respectively showing the light beam of the illuminating system in FIG. 2A being transmitted to the light guide element in different paths.

FIG. 4A to FIG. 4C are schematic diagrams of an illuminating system viewed from different viewing angles according to another embodiment of the present disclosure.

FIG. 5A and FIG. 5B are schematic diagrams respectively showing an illuminating system viewed from different viewing angles according to another embodiment of the present disclosure.

FIG. 6A and FIG. 6B are schematic diagrams respectively showing an illuminating system viewed from different viewing angles according to another embodiment of the present disclosure.

FIG. 7 is a three-dimensional schematic diagram of an illuminating system according to another embodiment of the present disclosure.

### DESCRIPTION OF EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

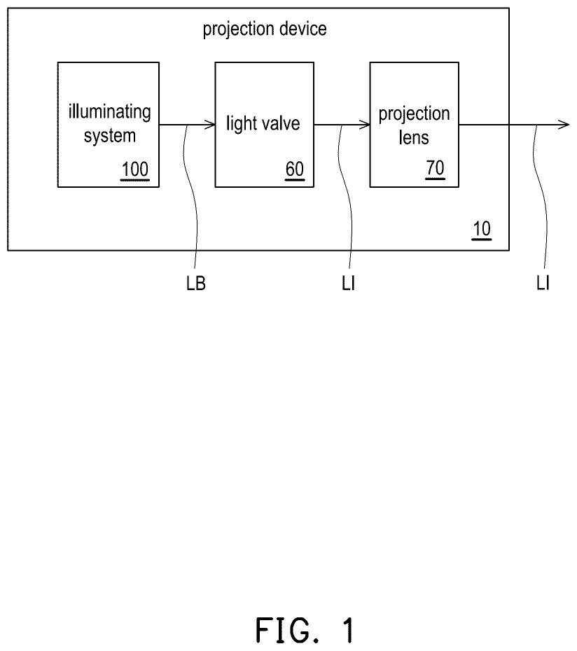

FIG. 1 is a schematic diagram of a projection device according to an embodiment of the present disclosure. Please refer to FIG. 1, the present embodiment provides a projection device 10, including an illuminating system 100, at least one light valve 60 and a projection lens 70. The illuminating system 100 is configured to provide the illuminating beam LB. At least one light valve 60 is disposed on the transmission path of the illumination beam LB to convert the illumination beam LB into the image beam LI. The projection lens 70 is disposed on the transmission path of the image beam LI, and is configured to project the image beam LI out of the projection device 10 to a projection target (not shown), such as a screen or a surface of a wall.

The light valve 60 is, for example, a reflective light modulator such as a liquid crystal on silicon panel (LCOS panel) or a digital micro-mirror device (DMD). In some embodiments, the light valve 60 may also be a transmissive optical modulators such as a transparent liquid crystal panel, an electro-optical modulator, a magneto-optic modulator, or an acousto-optic modulator (AOM). The present disclosure does not limit the form and type of the light valve 60. Sufficient teaching, suggestions and implementation instructions for the detailed steps and implementation of the method for converting the illumination beam LB into the image beam LI by at least one light valve 60 may be derived from common knowledge in the technical field, and therefore the details will not be described again. In different embodiments, the number of at least one light valve 60 may be set to be one to three, and the disclosure is not limited thereto.

The projection lens 70 includes, for example, a combination of one or more optical lenses with diopter. For example, combinations of non-planar lenses including at least one of biconcave lenses, biconvex lenses, meniscus lenses, convex-concave lenses, plano-convex lenses, and plano-concave lenses. In an embodiment, the projection lens 70 may further include a plane optical lens to project the image beam LI from the at least one light valve 60 to the projection target in a reflective manner. The present disclosure does not limit the form and type of the projection lens 70.

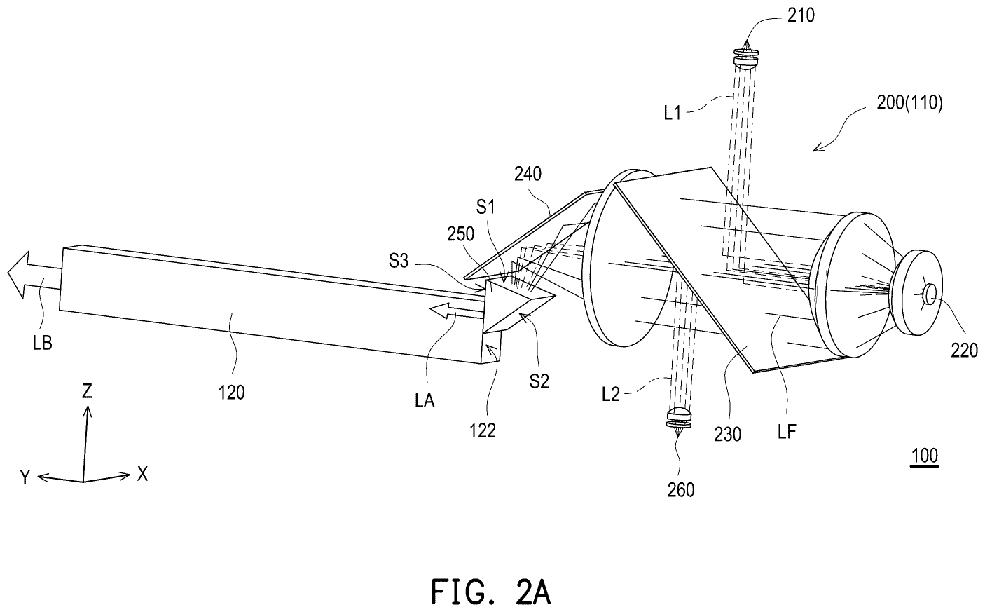

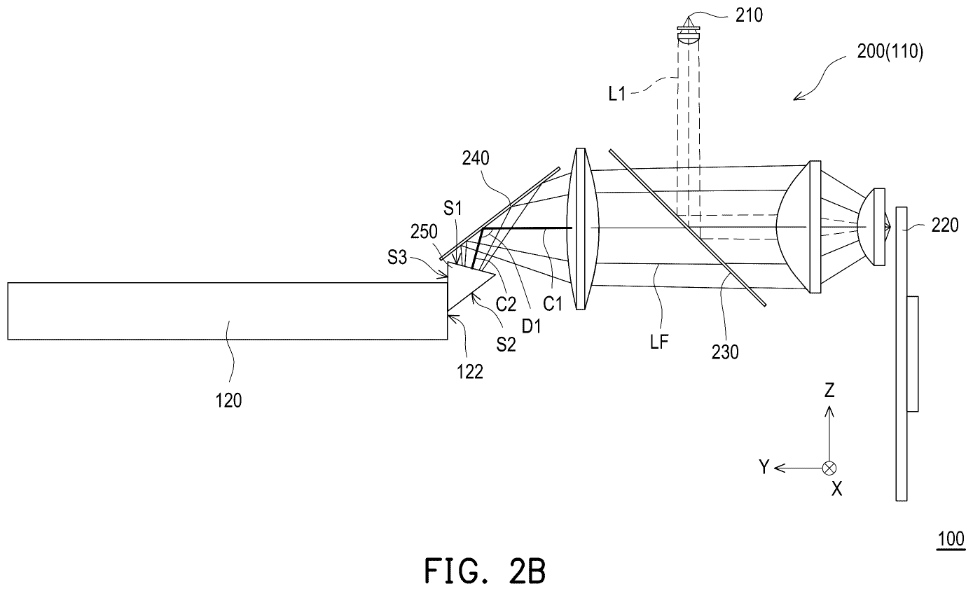

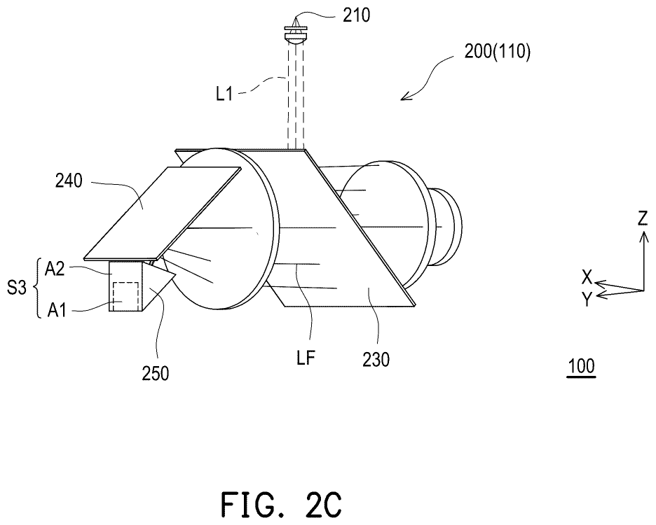

FIG. 2A to FIG. 2C are schematic diagrams of the illuminating system viewed from different viewing angles according to an embodiment of the present disclosure. The illuminating system 100 of this embodiment may be applied to at least the projection device 10 of FIG. 1. Please refer to FIG. 2A to FIG. 2C. The illuminating system 100 includes a light source module 110 and a light homogenizing element 120. The illuminating system 100 is configured to provide an illuminating beam LB. Relative to the wavelength conversion element 220 shown in FIG. 2B, the wavelength conversion element 220 in FIG. 2A and FIG. 2C is shown in a smaller size so that it doesn't intervene with other elements,. In addition, the light homogenizing element 120 is omitted in the illuminating system 100 shown in FIG. 2C, for convenience of explanation.

The light source module 110 includes at least one sub-light source module 200. Each sub-light source module 200 is configured to provide a sub-illumination beam LA. Each sub-light source module 200 includes a light-emitting element 210, a wavelength conversion element 220, a light-splitting element 230, a reflective element 240 and a light guide element 250. The light-emitting element 210 is configured to provide the first light beam L1. The light source module 110 of the illuminating system 100 of FIG. 2A to FIG. 2C is exemplified as a sub-light source module 200 in an embodiment. For example, the light-emitting element 210 is, for example, at least one laser diode (LD), a laser diode array, at least one light-emitting diode (LED), or/and a light-emitting diode array. In this embodiment, the light-emitting element 210 is a combination of at least one of at least one blue laser diode, at least one blue laser diode array, at least one blue light-emitting diode, and at least one blue light-emitting diode array for providing a blue first light beam. In other embodiments, when the number of sub-light source modules 200 is plural, the light-emitting elements 210 in different sub-light source modules 200 may be the combination of at least one of at least one blue laser diode, at least one blue laser diode array, at least one blue light-emitting diode, and at least one blue light-emitting diode array, and the disclosure is not limited thereto.

The light-splitting element 230 guides the first light beam LI provided by the light-emitting element 210 toward the wavelength conversion element 220. For example, in this embodiment, the light-splitting element 230 is, for example, a dichroic mirror with blue reflector (DMB), and allows other color lights to pass through. The wavelength conversion element 220 is disposed on the transmission path of the first light beam L1 from the light-splitting element 230, and converts the first light beam L1 into the excited light beam LF. For example, in this embodiment, the wavelength conversion element 220 includes a wavelength conversion area, and there is at least one wavelength conversion material (such as a phosphor material) disposed on the wavelength conversion region to convert the blue first light beam L1 into a yellow or/and green excited light beam LF.

When the wavelength conversion material of the wavelength conversion element 220 converts the first light beam L1 into the excited light beam LF, the excited light beam LF is transmitted to the light-splitting element 230 and guided to the reflective element 240 by the light-splitting element 230. In this embodiment, the wavelength conversion element 220 includes, for example, a metal substrate or a substrate having a reflective layer (not shown). The wavelength conversion material is disposed on the metal substrate or the reflective layer, such that the first light beam L1 or/and the excited light beam LF is reflected to the light-splitting element 230. Specifically, in this embodiment, the light-splitting element 230 is configured to reflect the first light beam L1 and allow the excited light beam LF to pass through.

The reflective element 240 is disposed on the transmission path of the excited light beam LF from the light-splitting element 230, and is configured to reflect the excited light beam LF toward the light guide element 250. In this embodiment, the reflective element 240 is configured such that the angle D1 between the incident optical axis C1 and the reflected optical axis C2 of the excited light beam LF transmitted to the reflective element 240 is greater than 90 degrees. In other words, compared with the conventional configuration, this embodiment deflects the reflective element 240 with the axial direction (i.e., the X axis in FIG. 2A) perpendicular to the incident optical axis C1 and the reflected optical axis C2, such that the reflective element 240 and the incident optical axis Cl of the excited light beam LF are not arranged with an angle at 45 degrees. That is, the angle between the incident optical axis C1 of the excited light beam LF entering the reflective element 240 and the incident surface of the reflective element 240 is not equal to 45 degrees. In other embodiments, the light-splitting element may also be disposed between the light-emitting element and the wavelength conversion element (not shown), so that the first light beam provided by the light-emitting element passes through the light-splitting element and is transmitted to the wavelength conversion element. The wavelength conversion element converts the first light beam into an excited light beam, and then the excited light beam is transmitted back to the light-splitting element. The light-splitting element then reflects the excited light beam to the reflective element.

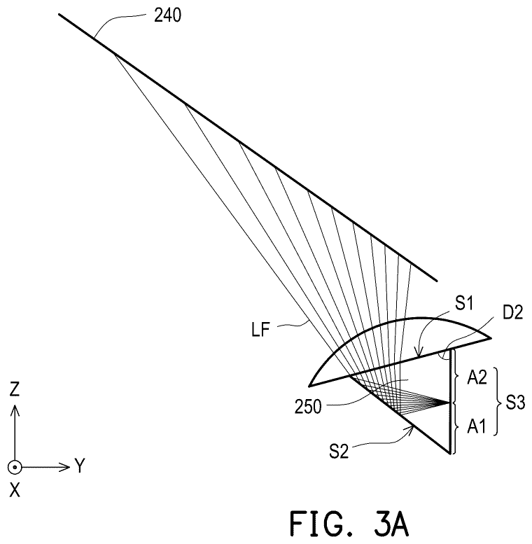

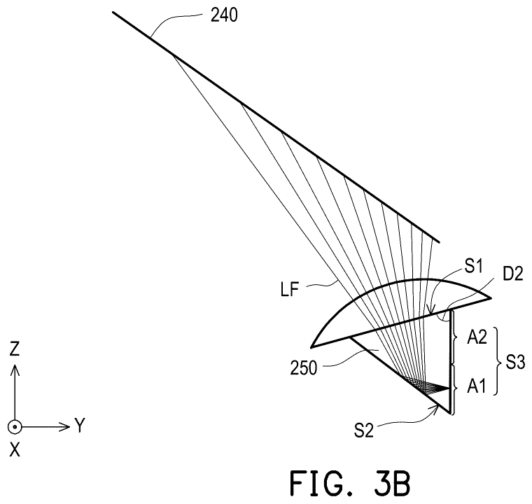

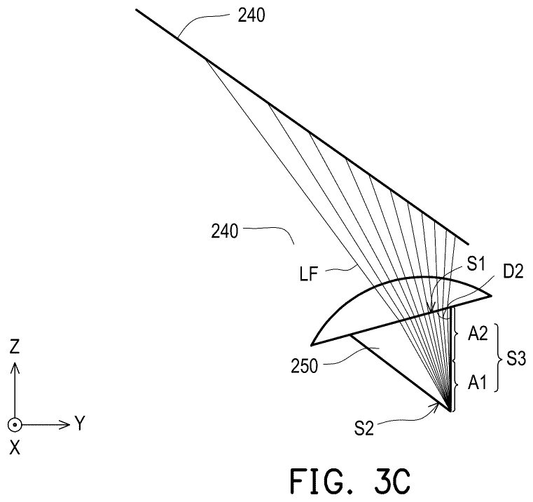

FIG. 3A to FIG. 3C are schematic diagrams respectively showing the light beam of the illuminating system in FIG. 2A being transmitted to the light guide element in different paths. Please also refer to FIG. 2A to FIG. 3C. The light guide element 250 is disposed between the reflective element 240 and the light homogenizing element 120, and includes a light incident surface S1, a reflective surface S2, and a light exit surface S3, wherein the light exit surface S3 includes a light-exiting area A1 and a non-light-exiting area A2. The light-exiting area A1 is further away from the light incident surface S1 than the non-light-exiting area A2, and the angle D2 between the light incident surface S1 and the light exit surface S3 is an acute angle. For example, the light guide element 250 is an isosceles triangle prism, but is not limited thereto. It may be clearly seen from the different optical paths shown in FIG. 3A to FIG. 3C that when the angle D2 between the light incident surface S1 and the light exit surface S3 is an acute angle, the excited light beam LF has less optical loss. The reflective element 240 is disposed corresponding to the light incident surface S1 of the light guide element 250, so that the excited light beam LF reflected by the reflective element 240 is transmitted into the light guide element 250 through the light incident surface S1 of the light guide element 250. In some embodiments, an optical lens (as shown in FIG. 3A to FIG. 3C) may be disposed between the reflective element 240 and the light incident surface S1 of the light guide element 250 to converge the excited light beam LF from the reflective element 240 to the light guide element 250, but the present disclosure is not limited thereto. Specifically, the reflected optical axis C2 of the excited light beam LF from the reflective element 240 is substantially perpendicular to the light incident surface S1 of the light guide element 250. The excited light beam LF in the light guide element 250 is reflected by the reflective surface S2 and exits the light guide element 250 through the light-exiting area A1 of the light exit surface S3, thereby forming at least a part of the sub-illumination beam LA. In this embodiment, an area of the light spot area formed by the excited light beam LF on the light exit surface S3 of the light guide element 250 is the same as the area of the light-exiting area A1. In this embodiment, at least one of the light incident surface S1 and the light exit surface S3 of the light guide element 250 may have an anti-reflective layer, or both the light incident surface S1 and the light exit surface S3 may have an anti-reflective layer, thereby reducing light reflection and improve the light transmission rate to avoid optical loss, but the disclosure is not limited thereto.

The light homogenizing element 120 includes a light input end 122, which is configured corresponding to the light-exiting area A1 of the light guide element 250, and is disposed on the transmission path of the sub-illumination beam LA from the sub-light source module 200 to receive the sub-illumination beam LA from the light-exiting area A1, and the illumination beam LB includes the sub-illumination beam LA. Specifically, the light input end 122 of the light homogenizing element 120 may be attached seamlessly to the light exit surface S3 of the light guide element 250, or be disposed apart from the light exit surface S3 of the light guide element 250 with an interval in between. The present disclosure is not limited thereto. In this embodiment, the light input end 122 of the light homogenizing element 120 may correspond to the light-exiting area A1 but not the non-light-exiting area A2 of the light exit surface S3 of the light guide element 250. Therefore, by designing the angle D2 between the light incident surface S1 and the light exit surface S3 of the light guide element 250 to be an acute angle, together with the deflection configuration of the reflective element 240, the excited light beam LF may enter the light guide element 250 through different transmission paths without optical loss. In this way, the light utilization efficiency may be improved, thereby enhancing the optical performance of the illumination beam LB. In this embodiment, the light homogenizing element 120 is, for example, a light integrating column.

On the other hand, in this embodiment, the sub-light source module 200 also includes a light source unit 260 for providing the second light beam L2 (only shown in FIG. 2A for illustration purposes). For example, the light source unit 260 may be a combination of at least one blue laser diode, at least one blue laser diode array, at least one blue light-emitting diode, and at least one blue light-emitting diode array, which provides a blue light beam. The wavelength range of the second light beam L2 may be designed to be the same as, partially the same as, or different from that of the first light beam L1, and the present invention is not limited thereto. The light-splitting element 230 directs the second light beam L2 emitted from the light source unit 260 to the reflective element 240, which then reflects the second light beam L2 to the light guide element 250. Accordingly, the configuration of the light source unit 260 enables the provision of different colors of light or an increase in brightness. In different embodiments, the light source unit 260 may include at least one first-color light-emitting element, at least one second-color light-emitting element, and at least one third-color light-emitting element, which respectively emit a first-color light, a second-color light, and a third-color light. The second light beam L2 includes at least one of the first-color light, the second-color light, and the third-color light. For example, the light source unit 260 may include any combination of red, green, and blue laser diodes and red, green, and blue light-emitting diodes to provide red, green, and/or blue light beams. The present invention is not limited thereto.

The second light beam L2 emitted from the light source unit 260 is guided to the reflective element 240 by the light-splitting element 230 and subsequently reflected by the reflective element 240 toward the light guide element 250. The second light beam L2 then exits the light guide element 250 from the light-emitting area A1 of the light exit surface S3 and continues to be transmitted to the light homogenizing element 120. Thus, the second light beam L2 constitutes at least part of the sub-illumination beam LA. Through the configuration of the light source unit 260 and the light-emitting element 210, illumination beams with different colors of light may be provided to the light valve 60 at different timings (as shown in FIG. 1).

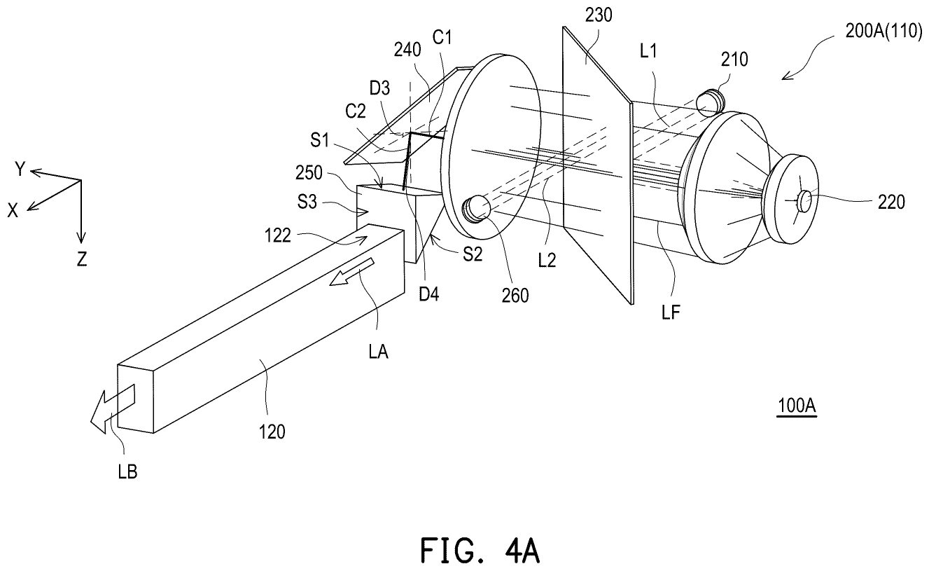

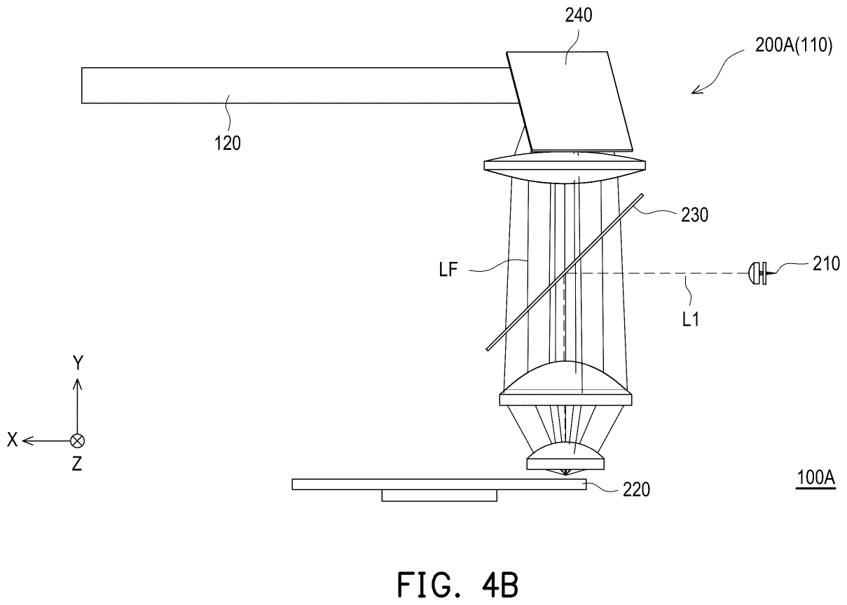

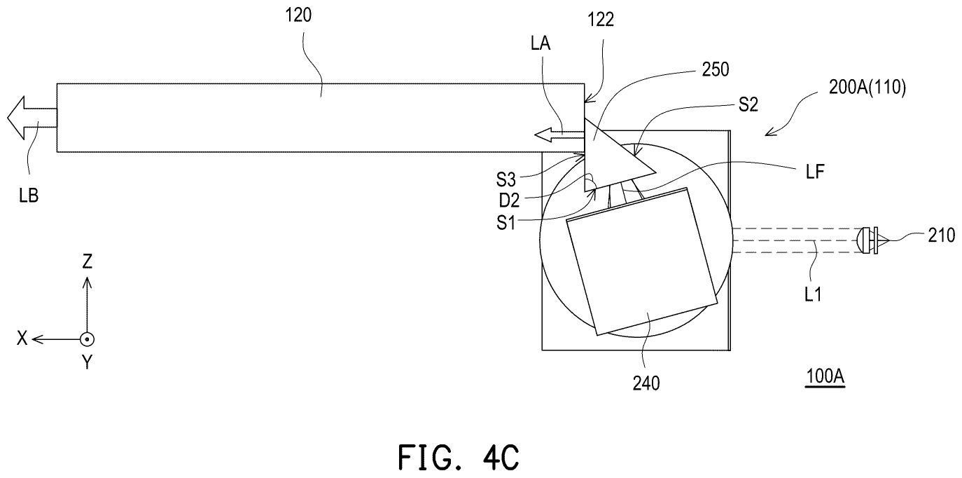

FIG. 4A to FIG. 4C are schematic diagrams illustrating an illuminating system from different viewing angles according to another embodiment of the present disclosure. To prevent the wavelength conversion element 220 from obstructing other components in FIG. 4A and FIG. 4C, it is scaled down for illustration purposes, whereas FIG. 4B presents the wavelength conversion element 220 in its normal proportions. The illuminating system 100A in this embodiment is similar to the illuminating system 100 shown in FIG. 2A. The primary difference between the two is that, in this embodiment, the arrangement of the light-emitting element 210, the light source unit 260, the light-splitting element 230, the light guide element 250, and the light homogenizing element 120 in the sub-light source module 200A is slightly different from that of the sub-light source module 200. Specifically, the reflective element 240 is deflected about the incident optical axis C1 (i.e., the Y-axis in FIG. 4A) of the excited light beam LF. In this embodiment, the first axial direction (i.e., the X-axis in FIG. 4A), which is perpendicular to the incident optical axis Cl of the excited light beam LF, forms an angle D3 with the reflective surface of the reflective element 240, where D3 is greater than or equal to 10 degrees and less than or equal to 20 degrees. Additionally, in the second axial direction (i.e., the Z-axis in FIG. 4A), which is also perpendicular to the incident optical axis Cl of the excited light beam LF, an off-axis angle D4 is formed between the reflected optical axis C2 of the excited light beam LF and the incident optical axis C1. The off-axis angle D4 is greater than or equal to 10 degrees and less than or equal to 20 degrees. As shown in FIG. 4B, due to the deflection configuration of the reflective element 240, the reflective element 240 appears to have a non-rectangular shape when viewed along the Z-axis. Therefore, by designing the angle D2 between the light incident surface S1 and the light exit surface S3 of the light guide element 250 to be an acute angle and incorporating the aforementioned deflection configuration of the reflective element 240, the excited light beam LF can enter the light guide element 250 along different transmission paths without optical loss. This improves light utilization efficiency, thereby enhancing the optical performance of the illumination beam LB.

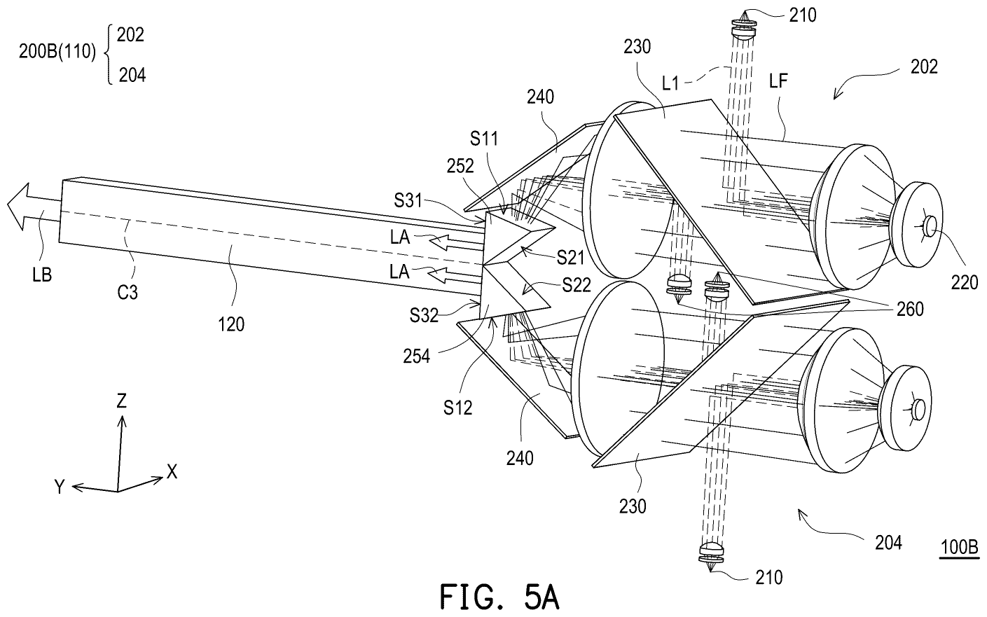

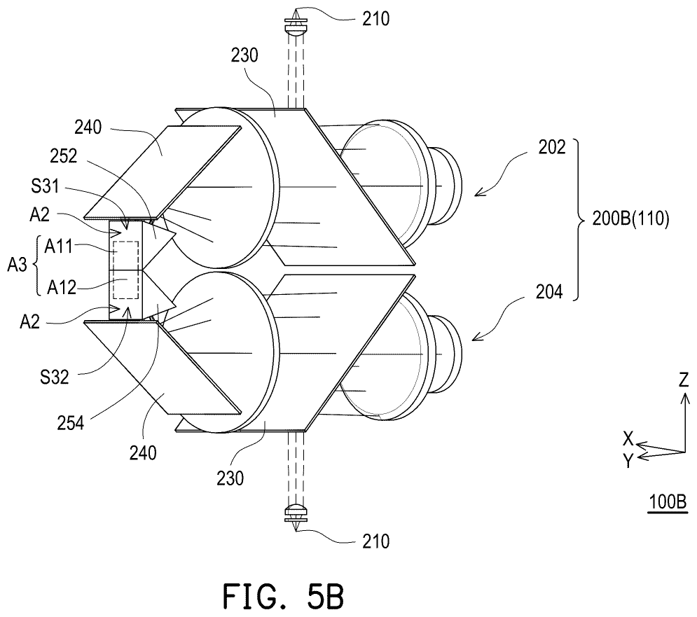

FIG. 5A and FIG. 5B are schematic diagrams respectively illustrating an illuminating system from different viewing angles according to another embodiment of the present disclosure. For ease of explanation, the illuminating system 100B shown in FIG. 5B does not display the light homogenizing element 120. Please refer to FIG. 5A and FIG. 5B. The illuminating system 100B shown in FIG. 5A is similar to the illuminating system 100 shown in FIG. 2A. The primary difference between the two is that, in this embodiment, the number of sub-light source modules 200B is two, and they are symmetrically arranged. Specifically, the sub-light source module 200B includes a first sub-light source module 202 and a second sub-light source module 204, both of which respectively incorporate the optical elements present in the sub-light source module 200 of the embodiment shown in FIG. 2A. Notably, in this embodiment, the light exit surface S31 of the light guide element 252 in the first sub-light source module 202 and the light exit surface S32 of the light guide element 254 in the second sub-light source module 204 are positioned adjacent to each other and are coplanar. Additionally, similar to the embodiment in FIG. 2A, the light input end 122 of the light homogenizing element 120 is aligned with the light-exiting area A11 of the light guide element 252 in the first sub-light source module 202 and the light-exiting area A12 of the light guide element 254 in the second sub-light source module 204. In this embodiment, the light exit surface S31 of the light guide element 252 and the light exit surface S32 of the light guide element 254 are positioned adjacent to each other without any gap. That is, the light-exiting area A11 of the light guide element 252 and the light-exiting area A12 of the light guide element 254 are seamlessly aligned.

Specifically, in this embodiment, the first sub-light source module 202 and the second sub-light source module 204 are respectively disposed on different sides of the extended central axis C3 of the light input end 122 of the light homogenizing element 120, and they are symmetrically arranged about the extended central axis C3 of the light homogenizing element 120. An area of the light spot area formed by the excited light beam LF from the first sub-light source module 202 on the light exit surface S31 of the light guide element 252 is the same as the area of the light-exiting area A11, and an area of the light spot area formed by the excited light beam LF from the second sub-light source module 204 on the light exit surface S32 of the light guide element 254 is the same as the area of the light-exiting area A12. The light spot areas of the first sub-light source module 202 (i.e., light-exiting area A11) and the second sub-light source module 204 (i.e., light-exiting area A12) are adjacent to each other and jointly form a combined light spot area A3. Furthermore, the orthographic projection of the combined light spot area A3 at the light input end 122 of the light homogenizing element 120 overlaps with the light input end 122 of the light homogenizing element 120. The orthographic projection of the light-exiting area A11 of the light guide element 252 of the first sub-light source module 202 on the light input end 122 of the light homogenizing element 120 does not overlap with the orthographic projection of the light-exiting area A12 of the light guide element 254 of the second sub-light source module 204 on the light input end 122 of the light homogenizing element 120. Through this configuration, the excited light beams LF generated by the two different sub-light source modules 200B can be collectively guided to the same light homogenizing element 120 without light loss, thereby enhancing light utilization efficiency and improving the optical performance of the illumination beam LB.

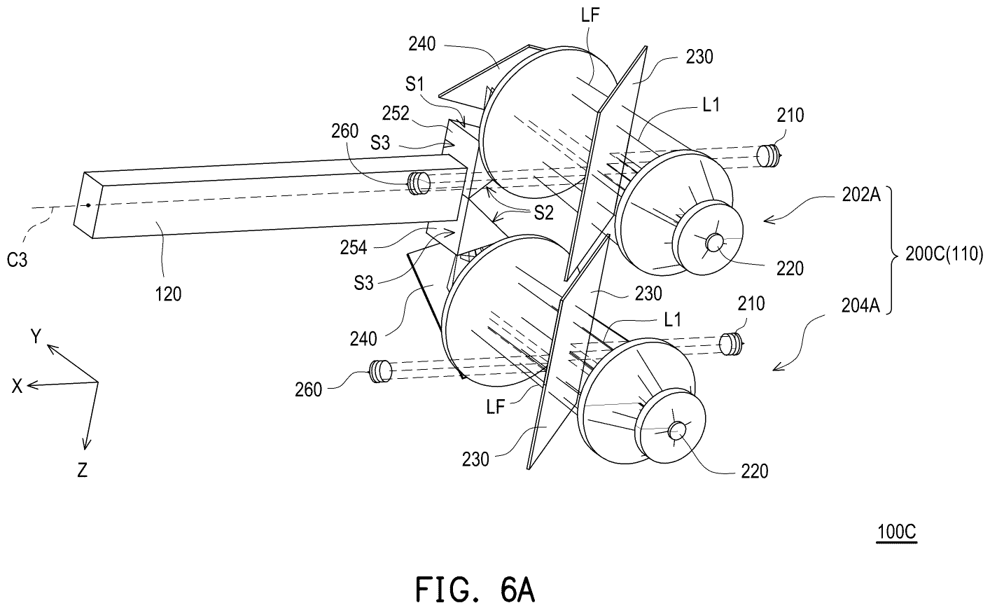

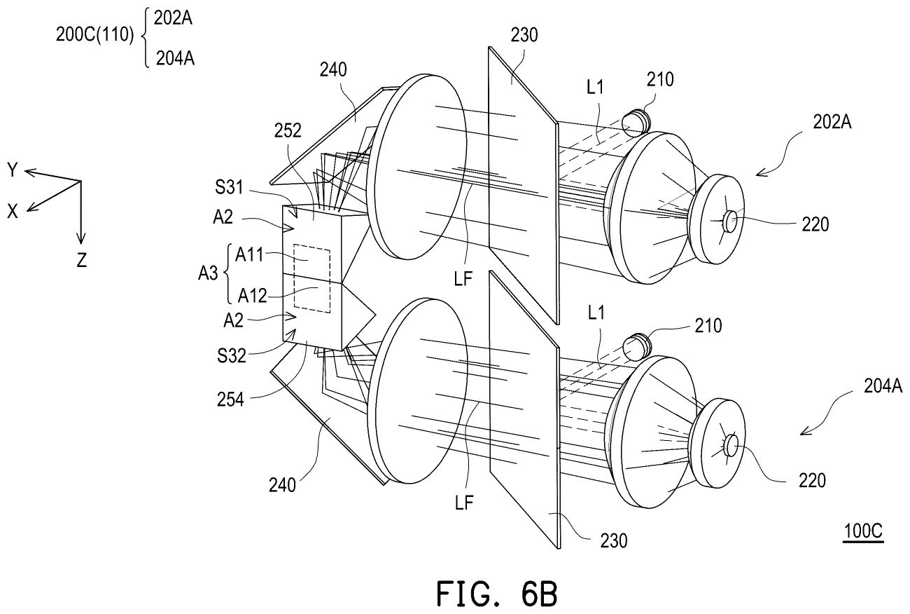

FIG. 6A and FIG. 6B are schematic diagrams respectively showing an illuminating system from different viewing angles according to another embodiment of the present disclosure. For ease of explanation, the illuminating system 100C shown in FIG. 6B does not show the light homogenizing element 120. Please refer to FIG. 6A and FIG. 6B. The illuminating system 100C shown in FIG. 6A is similar to the illuminating system 100A shown in FIG. 4A. The primary difference between the two is that, in this embodiment, the number of sub-light source modules 200C is two, and they are symmetrically arranged. Specifically, the sub-light source module 200C includes a first sub-light source module 202A and a second sub-light source module 204A, both of which respectively incorporate the optical elements present in the sub-light source module 200A of the embodiment shown in FIG. 4A. Notably, in this embodiment, the light exit surface S31 of the light guide element 252 in the first sub-light source module 202A and the light exit surface S32 of the light guide element 254 in the second sub-light source module 204A are positioned adjacent to each other and are coplanar. Additionally, similar to the embodiment in FIG. 4A, the light input end 122 of the light homogenizing element 120 is aligned with the light-exiting area A11 of the light guide element 252 in the first sub-light source module 202A and the light-exiting area A12 of the light guide element 254 in the second sub-light source module 204A.

Similar to the embodiment in FIG. 5A, in this embodiment, the first sub-light source module 202A and the second sub-light source module 204A are respectively disposed on different sides of the extended central axis C3 of the light input end 122 of the light homogenizing element 120, and they are symmetrically arranged about the extended central axis C3. Consequently, the light spot area of the first sub-light source module 202A (i.e., light-exiting area A11) and the light spot area of the second sub-light source module 204A (i.e., light-exiting area A12) are adjacent to each other and collectively form a combined light spot area A3. Furthermore, the orthographic projection of the combined light spot area A3 at the light input end 122 of the light homogenizing element 120 overlaps with the light input end 122 of the light homogenizing element 120. The orthographic projection of the light-exiting area A11 of the light guide element 252 of the first sub-light source module 202A and the orthographic projection of the light-exiting area A12 of the light guide element 254 of the second sub-light source module 204A at the light input end 122 of the light homogenizing element 120 do not overlap. This configuration enables the excited light beams LF generated by different sub-light source modules 200C to be collectively guided to the same light homogenizing element 120 without optical loss, thereby improving light utilization efficiency and enhancing the optical performance of the illumination beam LB.

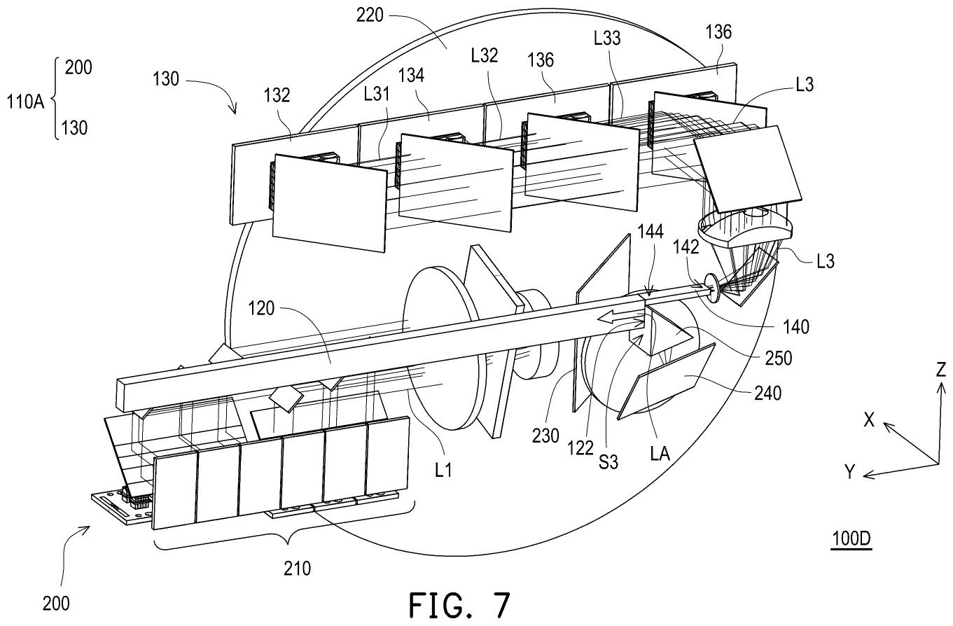

FIG. 7 is a three-dimensional schematic diagram of an illuminating system according to another embodiment of the present disclosure. Please refer to FIG. 7. The illuminating system 100D in this embodiment is similar to the illuminating system 100A shown in FIG. 4A. The primary difference is that the light source module 110A in this embodiment also includes a light-emitting unit 130 for providing a light beam L3, which enters the light homogenizing element 120 from the light input end 122. The light spot formed by the light beam L3 at the light input end 122 does not overlap with the light spot formed by the sub-illumination beam LA of the sub-light source module 200 at the light input end 122. In this embodiment, the light-emitting unit 130 includes at least one first-color light-emitting element 132, at least one second-color light-emitting element 134, and at least one third-color light-emitting element 136, which emit first-color light L31, second-color light L32, and third-color light L33, respectively. The light beam L3 includes at least one of the first-color light L31, second-color light L32, and third-color light L33. For instance, the first-color light-emitting element 132 may be any combination of at least one blue laser diode, at least one blue laser diode array, at least one blue light-emitting diode, and at least one blue light-emitting diode array, providing blue first-color light L31. The second-color light-emitting element 134 may be any combination of at least one green laser diode, at least one green laser diode array, at least one green light-emitting diode, and at least one green light-emitting diode array, providing green second-color light L32. The third-color light-emitting element 136 may be any combination of at least one red laser diode, at least one red laser diode array, at least one red light-emitting diode, and at least one red light-emitting diode array, providing third-color light L33 of red light.

In this embodiment, the illuminating system 100D further includes a light-collecting member 140, which further includes a light-collecting end 142 and a light-emitting end 144. For example, the light-collecting member 140 may be a light-integrating rod. The light-emitting end 144 of the light-collecting member 140 is aligned with at least part of the light input end 122 of the light homogenizing element 120, and it is coplanar with the light exit surface S3 of the light guide element 250 of the sub-light source module 200. The light-collecting member 140 is disposed on the transmission path of the light beam L3 and is arranged adjacent to the light guide element 250 of the sub-light source module 200. The light beam L3 enters the light-collecting member 140 from the light-collecting end 142 and exits from the light-emitting end 144 before entering the light homogenizing element 120 through the light input end 122. In another embodiment, the light-collecting member 140 may be integrally formed with the light homogenizing element 120.

In this embodiment, the wavelength conversion element 220 is shown schematically to illustrate that it converts the first light beam L1 into an excited light beam. The excited light beam in this embodiment corresponds to the sub-illumination beam LA of the sub-light source module 200. The light spot area formed by the excited light beam on the light exit surface S3 of the light guide element 250 is adjacent to the light spot area formed by the light beam L3 at the light-emitting end 144 of the light-collecting member 140, forming a combined light spot area. The orthographic projection of the combined light spot area at the light input end 122 of the light homogenizing element 120 overlaps with the light input end 122, enabling shared use of the light homogenizing element 120 without optical loss, thereby improving light utilization efficiency and enhancing the optical performance of the illumination beam LB.

In summary, the illuminating system and the projection device according to the embodiments of the present disclosure have at least one of the following advantages: In the illuminating system and projection device of the present disclosure, the illuminating system includes a light source module and a light homogenizing element. The light source module includes at least one sub-light source module, each of which is configured to provide a sub-illumination beam. Each sub-light source module includes a light-emitting element, a wavelength conversion element, a light-splitting element, a reflective element, and a light guide element. The wavelength conversion element converts the first light beam provided by the light-emitting element into an excited light beam, which is then reflected by the reflective element toward the light guide element. The light guide element includes a light incident surface, a reflective surface, and a light exit surface, where the angle between the light incident surface and the light exit surface is an acute angle. The light homogenizing element has a light input end that corresponds to the light-exiting area of the light guide element and is positioned along the transmission path of the sub-illumination beam from each sub-light source module to receive the sub-illumination beam from the light-exiting area. By utilizing the acute angle design between the light incident surface and the light exit surface of the light guide element, along with the deflection configuration of the reflective element, the excited light beam can be transmitted along different paths without causing optical loss. As a result, light utilization efficiency is enhanced, thereby improving the optical performance of the illumination beam.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An illuminating system, comprising a light source module and a light homogenizing element, wherein the illuminating system is configured to provide an illumination beam, wherein
the light source module comprises at least one sub-light source module, each of the at least one sub-light source module is configured to provide a sub-illumination beam, each of the at least one sub-light source module comprises a light-emitting element, a wavelength conversion element, a light-splitting element, a reflective element and a light guide element, wherein
the light-emitting element is configured to provide a first light beam;
the light-splitting element guides the first light beam provided by the light-emitting element toward the wavelength conversion element;
the wavelength conversion element is disposed on a transmission path of the first light beam from the light-splitting element and converts the first light beam into an excited light beam, and the excited light beam is transmitted to the light-splitting element and guided toward the reflective element by the light-splitting element;
the reflective element is disposed on a transmission path of the excited light beam from the light-splitting element, and is configured to reflect the excited light beam to the light guide element; and
the light guide element comprises a light incident surface, a reflective surface and a light exit surface, and the light exit surface comprises a light-exiting area and a non-light-exiting area; the light-exiting area is farther from the light incident surface than the non-light-exiting area; an angle between the light incident surface and the light exit surface is an acute angle; the reflective element is configured corresponding to the light incident surface of the light guide element, so that the excited light beam enters the light guide element from the light incident surface; the excited light beam in the light guide element is reflected by the reflective surface and exits the light guide element from the light-exiting area of the light exit surface, thereby forming at least a portion of the sub-illumination beam; and
the light homogenizing element comprises a light input end, the light input end is disposed corresponding to the light-exiting area of the light guide element of the at least one sub-light source module, and is disposed on a transmission path of the sub-illumination beam from each of the at least one sub-light source module to receive the sub-illumination beam from the light-exiting area, and the illumination beam comprises the sub-illumination beam.

2. The illuminating system according to claim 1, wherein an angle between an incident optical axis and a reflected optical axis of the excited light beam transmitted to the reflective element is greater than 90 degrees.

3. The illuminating system according to claim 1, wherein an angle between a first axial direction perpendicular to an incident optical axis of the excited light beam and a reflective surface of the reflective element is greater than or equal to 10 degrees and less than or equal to 20 degrees.

4. The illuminating system according to claim 3, wherein there is an off-axis angle between a second axial direction perpendicular to the incident optical axis of the excited light beam and a reflected optical axis of the excited light beam reflected from the reflective element, and the off-axis angle is greater than or equal to 10 degrees and less than or equal to 20 degrees.

5. The illuminating system according to claim 1, wherein a reflected optical axis of the excited light beam from the reflective element is perpendicular to the light incident surface of the light guide element.

6. The illuminating system according to claim 1, wherein an area of the light spot area formed by the excited light beam on the light exit surface of the light guide element is the same as an area of the light-exiting area.

7. The illuminating system according to claim 1, wherein the at least one sub-light source module comprises a first sub-light source module and a second sub-light source module, and the light exit surface of the light guide element of the first sub-light source module is adjacent to and coplanar with the light exit surface of the light guide element of the second sub-light source module.

8. The illuminating system according to claim 7, wherein the first sub-light source module and the second sub-light source module are respectively configured on different sides of a extended central axis of the light input end of the light homogenizing element, and are symmetrically arranged about the extended central axis.

9. The illuminating system according to claim 7, wherein an area of a light spot area formed by the excited light beams of the first sub-light source module and the second sub-light source module on the light exit surface of the light guide element is the same as an area of the light-exiting area, and the light spot area of the first sub-light source module and the light spot area of the second sub-light source module are adjacent to each other and jointly form a combined light spot area.

10. The illuminating system according to claim 9, wherein an orthographic projection of the combined light spot area at the light input end of the light homogenizing element overlaps a light input end of the light homogenizing element, and an orthographic projection of the light-exiting area of the light guide element of the first sub-light source module on the light input end of the light homogenizing element does not overlap with an orthographic projection of the light-exiting area of the light guide element of the second sub-light source module on the light input end of the light homogenizing element.

11. The illuminating system according to claim 1, wherein the at least one sub-light source module further comprises a light source unit, the light source unit is configured to provide a second light beam, and the light-splitting element guides the second light beam provided by the light source unit toward the reflective element, and the second light beam from the light-splitting element is reflected by the reflective element toward the light guide element.

12. The illuminating system according to claim 11, wherein the light source unit comprises at least one first-color light-emitting element, at least one second-color light-emitting element and at least one third-color light-emitting element, respectively configured to emit a first-color light, a second-color light and a third-color light, wherein the second light beam comprises at least one of the first-color light, the second-color light and the third-color light.

13. The illuminating system according to claim 1, wherein the number of the at least one sub-light source module is one, the light source module further comprises a light-emitting unit to provide a light beam, the light beam enters the light homogenizing element from the light input end of the light homogenizing element, a light spot formed by the light beam on the light input end does not overlap with a light spot formed by the sub-illumination beam of the sub-light source module on the light input end.

14. The illuminating system according to claim 13, further comprising a light-collecting member, the light-collecting member comprises a light-collecting end and a light-exiting end, the light-exiting end corresponds to at least part of the light input end of the light homogenizing element, and the light-exiting end of the light-collecting member is coplanar with the light exit surface of the light guide element of the sub-light source module, and the light-collecting member is disposed on a transmission path of the light beam and is adjacent to the light guide element of the sub-light source module, the light beam enters the light-collecting member from the light-collecting end and exits the light-collecting member from the light-exiting end, and then enters the light homogenizing element from the light input end of the light homogenizing element.

15. The illuminating system according to claim 13, wherein the light-emitting unit comprises at least one first-color light-emitting element, at least one second-color light-emitting element and at least one third-color light-emitting element, respectively configured to emit a first-color light, a second-color light and a third-color light, wherein the light beam comprises at least one of the first-color light, the second-color light and the third-color light.

16. The illuminating system according to claim 1, wherein the light guide element is an isosceles triangle prism.

17. A projection device, comprising an illuminating system, at least one light valve and a projection lens, wherein:
the illuminating system is configured to provide an illumination beam, and comprises a light source module and a light homogenizing element, wherein
the light source module comprises at least one sub-light source module, each of the at least one sub-light source module is configured to provide a sub-illumination beam, each of the at least one sub-light source module comprises a light-emitting element, a wavelength conversion element, a light-splitting element, a reflective element and a light guide element, wherein
the light-emitting element is configured to provide a first light beam;
the light-splitting element guides the first light beam provided by the light-emitting element toward the wavelength conversion element;
the wavelength conversion element is disposed on a transmission path of the first light beam from the light-splitting element, and converts the first light beam into an excited light beam, and the excited light beam is transmitted to the light-splitting element and guided toward the reflective element by the light-splitting element;
the reflective element is disposed on a transmission path of the excited light beam from the light-splitting element, and is configured to reflect the excited light beam to the light guide element; and
the light guide element comprises a light incident surface, a reflective surface and a light exit surface, and the light exit surface comprises a light-exiting area and a non-light-exiting area; the light-exiting area is further away from the light incident surface than the non-light-exiting area; an angle between the light incident surface and the light exit surface is an acute angle; the reflective element is configured corresponding to the light incident surface of the light guide element, so that the excited light beam enters the light guide element from the light incident surface, the excited light beam in the light guide element is reflected by the reflective surface and exits the light guide element from the light-exiting area of the light exit surface, thereby forming at least part of the sub-illumination beam; and
the light homogenizing element comprises a light input end, the light input end is configured corresponding to the light-exiting area of the light guide element of the at least one sub-light source module, and is disposed on a transmission path of the sub-illumination beam from each of the at least one sub-light source module to receive the sub-illumination beam from the light-exiting area, the illumination beam comprises the sub-illumination beam;
the at least one light valve is disposed on a transmission path of the illumination beam to convert the illumination beam into an image beam; and
the projection lens is disposed on a transmission path of the image beam and is configured to project the image beam out of the projection device.

18. The projection device according to claim 17, wherein an angle between an incident optical axis and a reflected optical axis of the excited light beam transmitted to the reflective element is greater than 90 degrees.

19. The projection device according to claim 17, wherein an angle between a first axial direction perpendicular to an incident optical axis of the excited light beam and a reflective surface of the reflective element is greater than or equal to 10 degrees and less than or equal to 20 degrees.

20. The projection device according to claim 19, wherein there is an off-axis angle between a second axial direction perpendicular to the incident optical axis of the excited light beam and a reflected optical axis of the excited light beam reflected from the reflective element, and the off-axis angle is greater than or equal to 10 degrees and less than or equal to 20 degrees.

21. The projection device according to claim 17, wherein a reflected optical axis of the excited light beam from the reflective element is perpendicular to the light incident surface of the light guide element.

22. The projection device according to claim 17, wherein an area of a light spot area formed by the excited light beam on the light exit surface of the light guide element is the same as an area of the light-exiting area.

23. The projection device according to claim 17, wherein the at least one sub-light source module comprises a first sub-light source module and a second sub-light source module, and the light exit surface of the light guide element of the first sub-light source module is adjacent to and coplanar with the light exit surface of the light guide element of the second sub-light source module.

24. The projection device according to claim 23, wherein the first sub-light source module and the second sub-light source module are respectively configured on different sides of a extended central axis of the light input end of the light homogenizing element, and are symmetrically arranged about the extended central axis.

25. The projection device according to claim 23, wherein a light spot area formed by the excited light beams of the first sub-light source module and the second sub-light source module on the light exit surface of the light guide element is the same as an area of the light-exiting area, and the light spot area of the first sub-light source module and the light spot area of the second sub-light source module are adjacent to each other and jointly form a combined light spot area.

26. The projection device according to claim 25, wherein an orthographic projection of the combined light spot area at the light input end of the light homogenizing element overlaps a light input end of the light homogenizing element, and an orthographic projection of the light-exiting area of the light guide element of the first sub-light source module on the light input end of the light homogenizing element does not overlap with an orthographic projection of the light-exiting area of the light guide element of the second sub-light source module on the light input end of the light homogenizing element.

27. The projection device according to claim 17, wherein the at least one sub-light source module further comprises a light source unit, the light source unit is configured to provide a second light beam, and the light-splitting element guides the second light beam provided by the light source unit toward the reflective element, and the second light beam from the light-splitting element is reflected by the reflective element toward the light guide element.

28. The projection device according to claim 27, wherein the light source unit comprises at least one first-color light-emitting element, at least one second-color light-emitting element and at least one third-color light-emitting element, respectively configured to emit a first-color light, a second-color light and a third-color light, wherein the second light beam comprises at least one of the first-color light, the second-color light and the third-color light.

29. The projection device according to claim 17, wherein the number of the at least one sub-light source module is one, the light source module further comprises a light-emitting unit to provide a light beam, the light beam enters the light homogenizing element from the light input end of the light homogenizing element, a light spot formed by the light beam on the light input end does not overlap with a light spot formed by the sub-illumination beam of the sub-light source module on the light input end.

30. The projection device according to claim 29, wherein the illuminating system further comprises a light-collecting member, the light-collecting member comprises a light-collecting end and a light-exiting end, the light-exiting end corresponds to at least part of the light input end of the light homogenizing element, and the light-exiting end of the light-collecting member is coplanar with the light exit surface of the light guide element of the sub-light source module, and the light-collecting member is disposed on a transmission path of the light beam and is adjacent to the light guide element of the sub-light source module, the light beam enters the light-collecting member from the light-collecting end and exits the light-collecting member from the light-exiting end, and then enter the light homogenizing element from the light input end of the light homogenizing element.

31. The projection device according to claim 29, wherein the light-emitting unit comprises at least one first-color light-emitting element, at least one second-color light-emitting element and at least one third-color light-emitting element, respectively configured to emit a first-color light, a second-color light and a third-color light, wherein the light beam comprises at least one of the first-color light, the second-color light and the third-color light.

32. The projection device according to claim 17, wherein the light guide element is an isosceles triangle prism.
